(19) United States
(12) Patent Application Publication
(10) Pub. No.: US 2021/0106180 A1
(43) Pub. Date: Apr. 15, 2021

(54) PORTABLE OTTOMAN FOR BATHTUB AND SHOWER

(71) Applicant: UNITED STATES GOVERNMENT AS REPRESENTED BY THE DEPARTMENT OF VETERANS AFFAIRS, Washington, DC (US)

(72) Inventors: Pascal Malassigné, Washington, DC (US); Mark W. Cors, Washington, DC (US); Kevin Alexander, Washington, DC (US)

(21) Appl. No.: 16/496,638

(22) PCT Filed: Mar. 29, 2018
(86) PCT No.: PCT/US2018/025291

§ 371 Date: Sep. 23, 2019

Related U.S. Application Data
(60) Provisional application No. 62/480,181, filed on Mar. 31, 2017.

(51) Int. Cl. A47K 3/12

(52) U.S. Cl. CPC A47K 3/125

(57) ABSTRACT

A portable ottoman is described. The portable ottoman can be placed on the bathing surface of a right-hand or left-hand bathtub or placed on the bathing surface of a shower and is designed for use by ambulatory or non-ambulatory individuals. The portable ottoman can also be used in a non-bathing environment, for example to assist with dressing. The portable ottoman has two or more legs, each leg having one or more feet. The portable ottoman rests on two or more feet that are positioned on the bathing surface or on the floor surface adjacent to the user.

### RELATED APPLICATION

The present application claims priority to U.S. provisional patent application No. 62/480,181 filed 31 Mar. 2017, which is incorporated herein by reference in its entirety.

### GOVERNMENT RIGHTS

The U.S. Government has a paid-up license in this invention and the right in limited circumstances to require the patent owner to license others on reasonable terms as provided for by the terms of Grant No. F0627-R awarded by The Department of Veterans Affairs.

### BACKGROUND

### Field of the Invention

The present disclosure generally relates to bathing devices and more particular relates to a portable ottoman that can be used in the bathtub or shower.

### Related Art

Devices that assist in bathing or showering are common among the elderly and disabled patient population. The National Center for Health Statistics has reported that about 10 percent of all people over the age of 65 have difficulty bathing, and about 6 percent receive help. In an assessment of home aids, adaptations and personal assistance received after traumatic spinal cord injury (“SCI”) in a population of 2.5 million inhabitants in Denmark, the most common aids or adaptations reported were related to the bathtub or shower (69%). Despite the increased awareness for bathroom assistance, no room at home poses more threats to safety than the bathroom. The National Safety Council reports that 7.8% of all injury episodes in the bathroom involved persons of age 65 or older. This is because the greatest danger in the bathroom is slipping and falling when entering and exiting the bathtub or shower.

To meet the needs of the aging population, the home health care services industry has grown from 40.8 million dollars in 2005 to 57.2 million dollars in 2009. Similar growth is predicted into the future based on the growing number of aging individuals entering retirement and desiring to stay within their homes. During this same period, the accessible bathtub and shower industry grew from 119.1 million dollars in 2005 to 148.5 million dollars in 2010. A similar growth rate was seen in the bath and pool lift industry that grew from 36.6 million dollars in 2005 to 45.6 million dollars in 2010. This growth rate of 4.5% per year is projected to continue as the boomers retire.

Individuals with spinal cord injury/dysfunction confront equivalent or even more significant challenges in the bathroom. There are approximately 12,000 new cases of spinal cord injury each year. Of these injuries, 52% have tetraplegia and 45% have paraplegia (National Spinal Cord Injury Statistics Center). This level of injury leads to diminished abilities and, in some cases, individuals will require caregiver assistance for bathing and other activities of daily life. The National Spinal Cord Injury Statistics Center (“NSCISC”) in Birmingham, Ala., tracks over 91% of this population as living in private residences. The need to remain in the home is as compelling for a spinal cord injured patient as it is for the aging because remaining in the home prolongs independence, reduces health care costs and maintains a high quality of life.

Therefore, what is needed is a system and method that overcomes these significant problems found in the conventional systems as described above.

### SUMMARY

The present disclosure describes a portable ottoman for use with a conventional bathtub or shower. The portable ottoman can be placed within a right hand or a left hand bathtub or a shower stall as a companion piece to a bathing seat or other bathing device. The portable ottoman may also be used in non-bathing settings as a companion piece to a wheelchair, a bed or any other surface or furniture upon which an individual may be positioned. The portable ottoman is configured for use by ambulatory or non-ambulatory individuals. The portable ottoman is configured to rest on two or more feet where all feet are positioned on the bathing surface of the bathtub or shower stall. The portable ottoman can advantageously be employed as a companion piece to a bathing chair or other bathing apparatus or other non-bathing surface or furniture.

The present disclosure describes a novel portable ottoman that can be placed equally within a right-hand or left-hand bathtub or shower stall and is configured for use by ambulatory or non-ambulatory individuals and/or individuals with SCI or other disabilities who cannot transfer to the bottom of a normal bathtub or stand in the shower for prolonged periods. The portable ottoman rests on two or more feet that are positioned on the bathing surface within a bathtub or shower stall and operates as a companion piece to a bathing seat, wheelchair, a bed or any other surface or furniture upon which an individual may be positioned. Alternatively, the portable ottoman may be placed on the floor surface of a shower. Alternatively, the portable ottoman may be placed on a non-bathing floor surface adjacent to where the subject is positioned.

Whether in the bathtub or the shower or otherwise, the portable ottoman assists in the bathing or dressing of individuals within a home or other facility. The portable ottoman contains several features that assist users in bathing or dressing. These features include a foot well with side walls that prevent the legs from inadvertently sliding off of the ottoman, an angled platform extending down into the foot well, a drain at the bottom of the foot well to allow fluid to flow from the foot well onto the bathing surface, a cushion on the angled platform and the side walls, and a handle to facilitate portability of the ottoman.

Certain advantages of the portable ottoman include that it is configured for use by ambulatory and non-ambulatory individuals and configured for use in a bathing environment or a non-bathing environment. The portable ottoman is configured for use with a right hand or left hand bathtub, configured to fit a variety of standard bathtub widths and shower widths, configured with an angled platform, and configured to drain onto the bathing surface of the bathtub or shower.

Additional advantages of the portable ottoman include that the ottoman functions to raise the feet while bathing or dressing which increases the safety of the activity as well as the comfort and convenience for bathers or dressers with a spinal cord injury. The portable ottoman helps with access to washing the feet and places the person into a very stable seated position, making it harder to fall forward and thereby increasing safety. The portable ottoman also creates a sense of relaxation that reminds subjects of taking a nice, long relaxing warm bath.

Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings in which like reference numerals refer to like parts.

FIG. 1A is a perspective view diagram illustrating an example portable ottoman according to an embodiment of the invention.

FIG. 1B is a top view diagram illustrating an example portable ottoman according to an embodiment of the invention.

FIG. 1C is a perspective view diagram illustrating an example portable ottoman according to an embodiment of the invention.

FIG. 1D is a left side view diagram illustrating an example portable ottoman according to an embodiment of the invention.

FIGS. 2A-2C are schematic view diagrams illustrating example dimensions of a portable ottoman according to an embodiment of the invention.

FIG. 3 is a perspective view diagram illustrating an example portable ottoman positioned on a shower bathing surface according to an embodiment of the invention.

FIG. 4 is a perspective view diagram illustrating an example portable ottoman positioned on a bathtub bathing surface according to an embodiment of the invention.

FIG. 5 is a perspective view diagram illustrating an example portable ottoman in use by a bathing subject having a foot and lower leg resting on the angled platform of the portable ottoman according to an embodiment of the invention.

FIG. 6 is a perspective view diagram illustrating an example portable ottoman in use by a dressing subject having a both feet and lower leg resting on the angled platform of the portable ottoman according to an embodiment of the invention.

FIG. 7 is a perspective view diagram illustrating an example portable ottoman being positioned on a bathtub bathing surface according to an embodiment of the invention.

FIG. 8 is a perspective view diagram illustrating an example portable ottoman being lifted off of a bathtub bathing surface according to an embodiment of the invention.

### REFERENCE NUMERALS

10 portable ottoman
20 leg
25 foot
30 right side wall
32 back side wall
34 left side wall
36 front side wall
40 well
50 handle
60 drain
70 cushion
80 bathing surface
90 non-bathing surface
100 angled platform
110 bathtub
200 bather
210 dresser
220 companion piece

### DETAILED DESCRIPTION

Certain embodiments disclosed herein provide for a portable ottoman configured to be placed on the bathing surface of a conventional bathtub or a conventional shower stall. The portable ottoman is used by a bather seated in a seat of a bathtub or seated in a shower stall seat. The ottoman is positioned in front of the user in order to elevate the legs to a safe and comfortable position for cleaning the legs and feet. For example, one embodiment disclosed herein includes a portable ottoman that includes two or more feet that support an angled platform upon which the feet and lower legs of a subject may rest during bathing or dressing. Whether in a bathtub or shower or a dressing area, the portable ottoman assists in the bathing and/or dressing of individuals within a home or other facility. The portable ottoman allows the bather to take advantage of existing bathing facilities such as plumbing for bathing water and drainage. After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

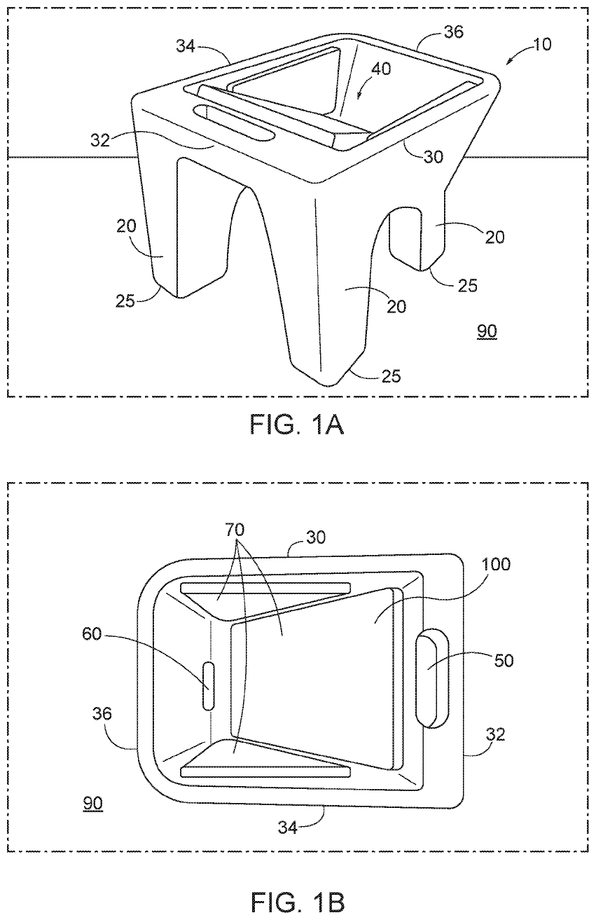

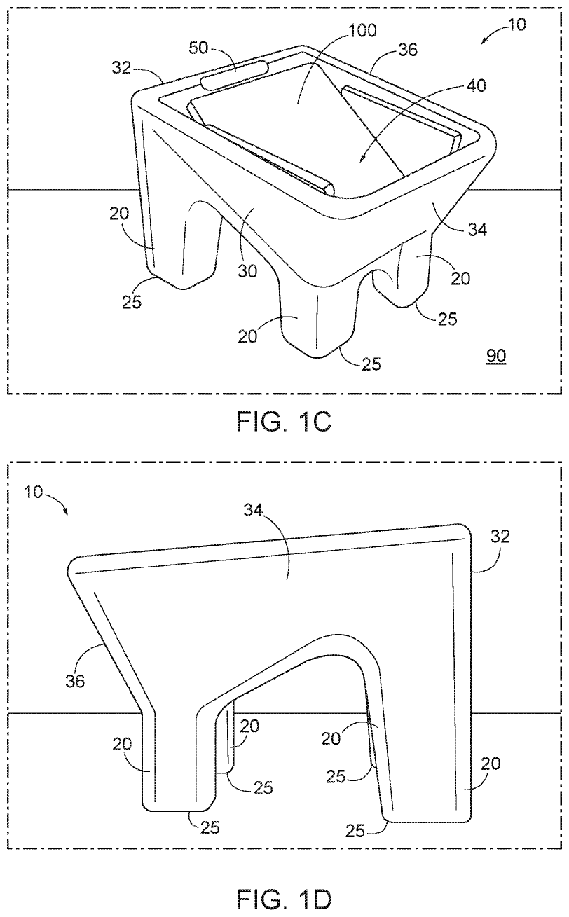

Referring now to FIGS. 1A-FIG. 8 of the drawings, various views of various embodiments of a portable ottoman 10 are provided. In the illustrated embodiments, the portable ottoman 10 comprises an angled platform 100 that is positioned above a bathing surface 80 by one or more legs 20, wherein each leg 20 has one or more feet 25. The angled platform 100 has a top surface, a bottom surface, a left side, a right side, an upper side and a lower side. The angled platform 100 also includes plurality of side walls extending upward from one or more of the left side, right side, upper side and lower side. The side walls may include left and right side walls (30, 34) and front and back side walls (36, 32). In one embodiment, there is no back side wall extending upward from the upper side of the angled platform. Together, the side walls define a well 40 into which a subject's feet and lower legs may be placed. At or near a junction of a lower portion of the angled platform 100 and the front side wall 36 there is a drain 60 to allow fluid to drain from the well 40. In one embodiment, a plug may be provided to seal the drain. Advantageously, the angled platform 100 and one or more of the sidewalls 30, 32, 34 and 36 may be at least partially covered by one or more cushions 70. Additionally, at or near an upper portion of the angled platform 100, the portable ottoman 10 may include a handle 50 to facilitate grasping and lifting the portable ottoman 10.

In one embodiment, the portable ottoman 10 comprises an angled platform 10 that has a top surface and a bottom surface, an upper side, a lower side, a right side and a left side. The lower side of the angled platform 10 is closer to the bathing surface 80 than the upper side of the angled platform 10. The portable ottoman 10 includes at least two legs 20, each having one or more feet 25, wherein at least a portion of the one or more feet 25 are configured to engage the bathing surface 80 and the at least two legs 20 further engage the angled platform 100 to secure the angled platform 100 above the bathing surface 80. Advantageously, the feet 25 may include a gripping material to prevent the portable ottoman 80 from sliding on the bathing surface 80. The portable ottoman 80 also includes a handle 50 that is proximal the upper side of the angled platform 100. The portable ottoman 80 also includes a drain 60 that is proximal the lower side of the angled platform 100. Advantageously, the drain 60 is configured to allow fluid to pass through the portable ottoman 10 toward the bathing surface 80.

In one embodiment, the portable ottoman 10 further includes a cushion 70 that is positioned on at least a portion of the top surface of the angled platform 100. Additionally, the portable ottoman 10 may also include a left side wall 34 extending upward from the left side of the angled platform 100 and a right side wall 30 extending upward from the right side of the angled platform 100. The left and right side walls 34 and 30 may also include a cushion 70 that is positioned on at least a portion of the surfaces of the left or right side walls 34 and 30 that face each other. In various embodiments, the cushion may be made of a foam material.

In one embodiment, the angle of the angled platform 100 is in the range of 20% to 70%. Additionally, in one embodiment the angled platform 100, the at least two legs 20, the handle 50 and the drain 60 are all formed as a single piece of molded plastic.

In one embodiment, the portable ottoman 10 further comprises a front side wall 36 extending upward from the lower side of the angled platform 100. In such an embodiment, the combination of the left and right and front side walls 34, 30 and 36 and the angled platform 100 form a well 40 into which the feet and lower legs of a subject may be positioned, for example during bathing or dressing. In such an embodiment, a plug may be positioned in the drain to allow the well 40 to fill with a fluid, for example to assist with bathing. Advantageously, the drain 60 may be positioned at a lowest point proximal to a position where the front side wall extends upward from the lower side of the angled platform to facilitate draining fluid from the well 40 and onto the bathing surface 80. Moreover, in one embodiment, the drain 60 comprises a hole extending from the top surface of the angled platform 100 to the bottom surface of the angled platform 100. Advantageously, the drain 60 may also include an elongated edge configured to operate as a second handle.

In one embodiment, one or more of the legs 20 may be configured to extend and contract in length to allow the portable ottoman 10 to be appropriately positioned for an individual subject. Additionally, in alternative embodiments, the portable ottoman 10 may include exactly three legs or exactly four legs. In a three leg embodiment, the portable ottoman 10 may include a single leg proximal the upper side of the angled platform 100 and two legs proximal the lower side of the angled platform 100. Conversely, in an alternative three leg embodiment, the portable ottoman 10 may include two legs proximal the upper side of the angled platform 100 and a single leg proximal the lower side of the angled platform 100.

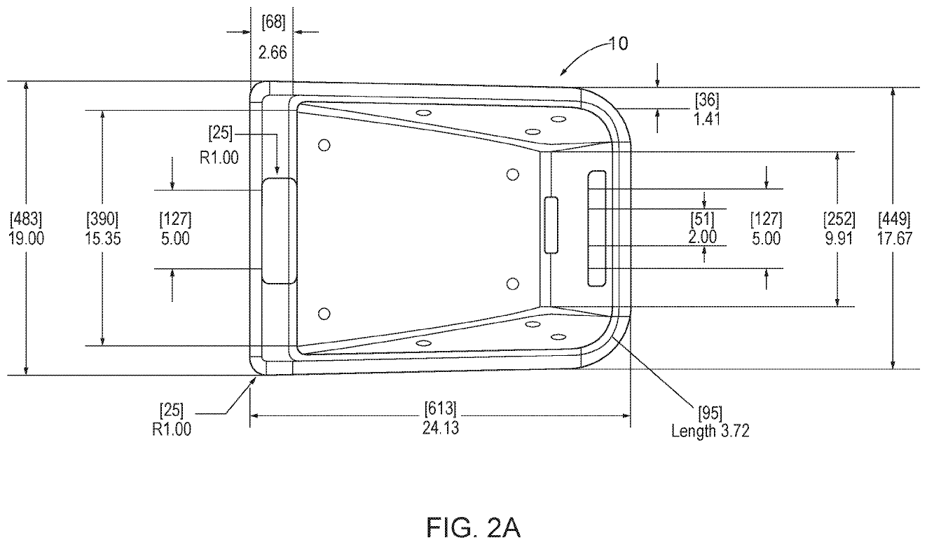

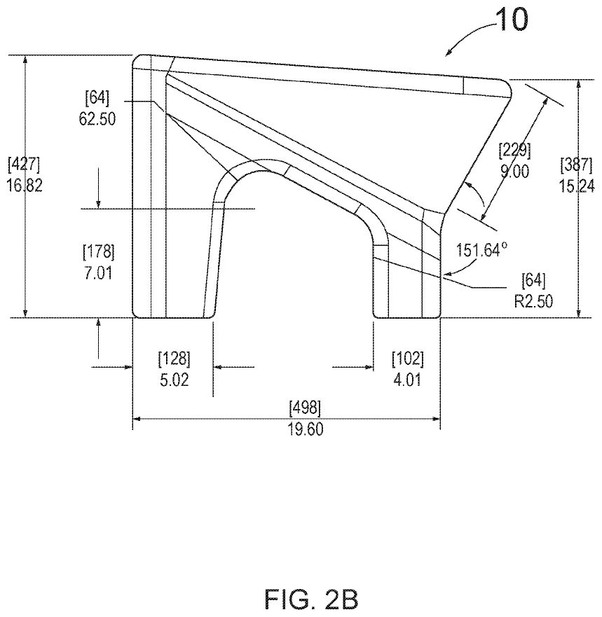

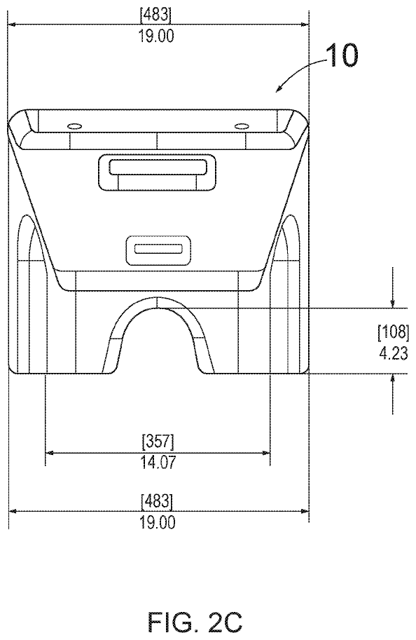

FIGS. 2A, 2B, and 2C are schematic view diagrams illustrating example dimensions of a portable ottoman 10 according to an embodiment of the invention. In one embodiment, the dimensions of the portable ottoman 10 allow the portable ottoman 10 to be positioned with each of its feet 25 on the bathing surface 80 of a standard bathtub.

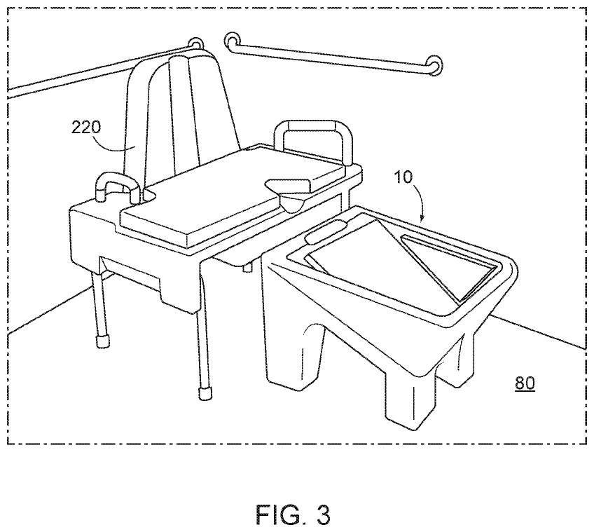

FIG. 3 is a perspective view diagram illustrating an example portable ottoman 10 positioned on a shower bathing surface 80 according to an embodiment of the invention. In the illustrated embodiment, the portable ottoman 10 is position adjacent to a companion piece 220. Advantageously, the portable ottoman 10 operates in cooperation with the companion piece 220 to allow a bather to more easily use the bathing facilities.

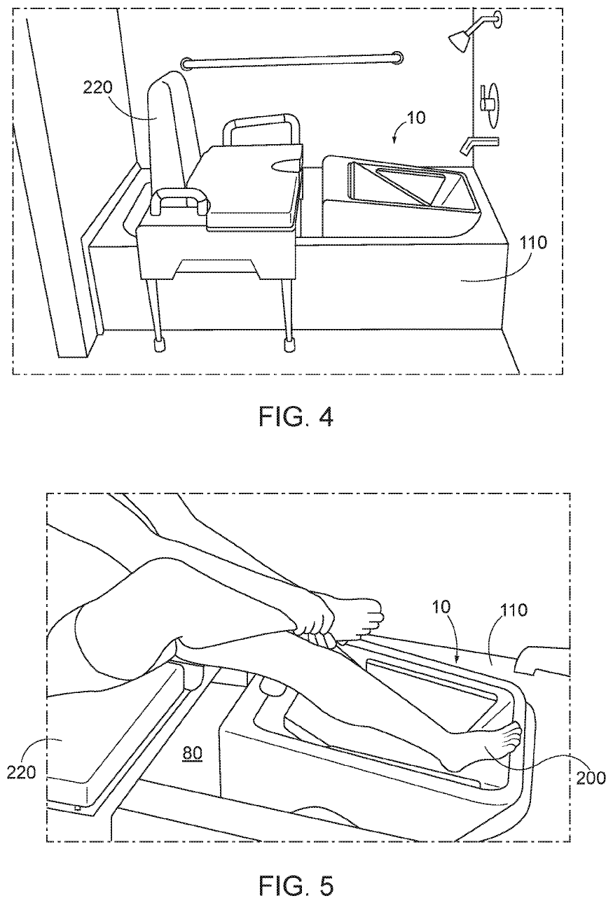

FIG. 4 is a perspective view diagram illustrating an example portable ottoman 10 positioned on a bathtub bathing surface according to an embodiment of the invention. In the illustrated embodiment, the portable ottoman 10 is positioned with each of its feet 25 on the bathing surface 80 of the bathtub 110. Additionally, the portable ottoman 10 is positioned adjacent to a companion piece 220. Advantageously, the portable ottoman 10 operates in cooperation with the companion piece 220 to allow a bather to more easily use the bathing facilities.

FIG. 5 is a perspective view diagram illustrating an example portable ottoman 10 in use by a bathing subject 200 having a foot and lower leg resting on the angled platform 100 of the portable ottoman 10 according to an embodiment of the invention. In the illustrated embodiment, the portable ottoman 10 is positioned with each of its feet 25 on the bathing surface 80 of the bathtub 110. Additionally, the portable ottoman 10 is positioned adjacent to a companion piece 220. Advantageously, the portable ottoman 10 operates in cooperation with the companion piece 220 to allow a bather to more easily use the bathtub 110.

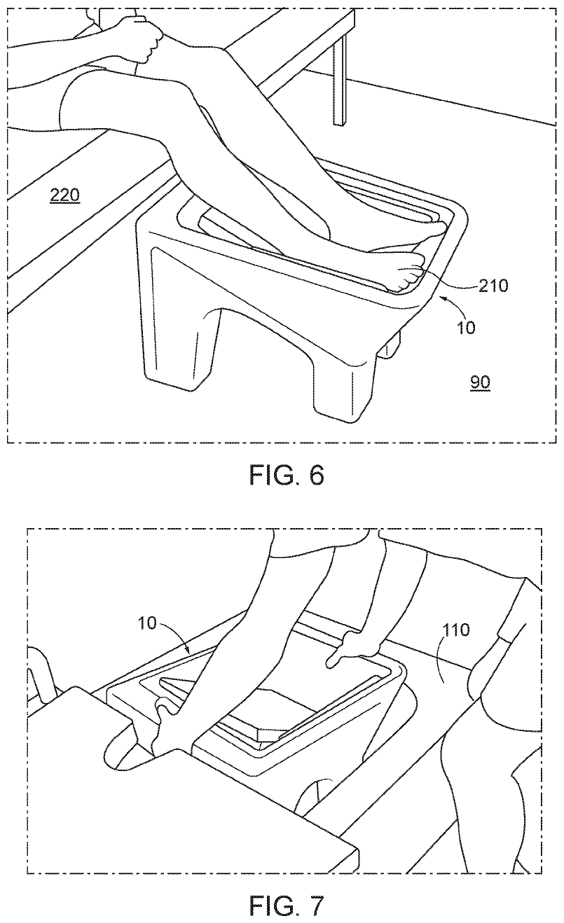

FIG. 6 is a perspective view diagram illustrating an example portable ottoman 10 in use by a dressing subject 210 having a both feet and lower leg resting on the angled platform 100 of the portable ottoman 10 according to an embodiment of the invention. In the illustrated embodiment, the portable ottoman 10 is positioned with each of its feet 25 on a non-bathing surface 90. In one embodiment, the non-bathing surface 90 may be the floor of a hospital room. Additionally, the portable ottoman 10 is positioned adjacent to a companion piece 220. In one embodiment, the companion piece 220 may be a bed in a hospital room. Advantageously, the portable ottoman 10 operates in cooperation with the companion piece 220 to allow a dresser to more easily get dressed.

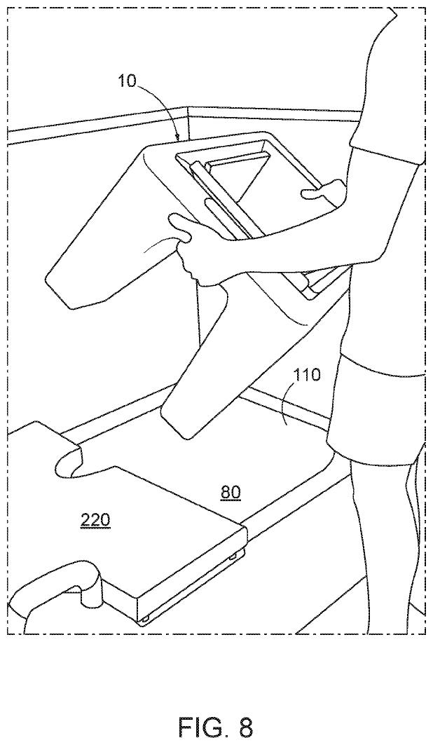

FIG. 7 is a perspective view diagram illustrating an example portable ottoman 10 being positioned on a the bathing surface 80 of a bathtub 110 according to an embodiment of the invention. In the illustrated embodiment, the dimensions of the portable ottoman 10 allow for all of the feet of the portable ottoman 10 to be positioned on the bathing surface 80 of the bathtub 110.

FIG. 8 is a perspective view diagram illustrating an example portable ottoman 10 being lifted off of the bathing surface 80 of a bathtub 110 according to an embodiment of the invention. In the illustrated embodiment, the dimensions of the portable ottoman 10 allow for the portable ottoman 10 to be easily lifted from or placed down upon the bathing surface 80 of the bathtub 110 when a companion piece 220 is already positioned in a portion of the bathtub 110.

### Example Embodiments

In one embodiment, a portable ottoman includes at least two legs, each having one or more feet. At least a portion of the one or more feet are configured to engage a bathing or non-bathing surface to support the portable ottoman. The at least two legs further engage an angled platform having a top surface and a bottom surface, an upper side, a lower side, a right side and a left side. The at least two legs are configured to secure the angled platform above the bathing or non-bathing surface. The portable ottoman also includes a handle positioned near an upper side of the angled platform and a drain positioned near the lower side of the angled platform.

In this embodiment, the portable ottoman may also include a cushion positioned on at least a portion of the top surface of the angled platform. The cushion may optionally be made from a foam material. In this embodiment, the portable ottoman may also include a left side wall extending upward from the left side of the angled platform and a right side wall extending upward from the right side of the angled platform. The left and right sidewalls advantageously function to keep the feet and legs of a bather/dresser upon the angled platform of the portable ottoman. This is particularly advantageous for bathers/dressers who are paraplegic or have some other disability that results in minimal or no ability for the bather/dresser to move his or her legs.

In this embodiment, the portable ottoman may also include a cushion positioned on at least a portion of the left side wall and the portable ottoman may also include a cushion positioned on at least a portion of the right side wall. In this embodiment, the angle of the angled platform is in the range of 20% to 70%.

In this embodiment, the portable ottoman may also include a front side wall extending upward from the lower side of the angled platform. In this embodiment, the drain of the portable ottoman is positioned at a lowest point near to where the front side wall extends upward from the lower side of the angled platform. Advantageously, this position facilitates maximum drainage of fluids out of the well of the portable ottoman. An optional feature in this embodiment is that the legs may be configured to extend and contract in length. In alternative versions of this embodiment, the portable ottoman may have exactly two legs, exactly three legs, or exactly four legs.

In this embodiment, the drain of the portable ottoman may comprise a hole extending through at least a portion of a bottom surface of the angled platform. An optional feature in this embodiment is for the drain to comprise an elongated edge configured to operate as a second handle. In this embodiment, the portable ottoman may also include a plug configured to seal the drain. In one embodiment, the angled platform, the at least two legs, the handle and the drain are all formed as a single piece of molded plastic.

Those of skill in the art will appreciate that the various illustrative blocks, features and elements described in connection with the figures and the embodiments disclosed herein can often be implemented using alternative materials and alternative shapes that carry out the same functions described herein. To clearly illustrate this interchangeability, various illustrative components, blocks, features, and steps have been described above generally in terms of their functionality. Whether such functionality is implemented precisely as described above depends upon the particular application and design constraints imposed on the overall system. Skilled persons can implement the described functionality in varying ways for each particular application, but such implementation decisions should not be interpreted as a departure from the scope of the invention. In addition, the grouping of functions within a particular module, block, or step is for ease of description. Specific functions or steps can be moved from one module, block or step to another without departing from the scope of the invention.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. A portable ottoman comprising:
an angled platform having a top surface and a bottom surface, an upper side, a lower side, a right side and a left side;
at least two legs, each having one or more feet, wherein at least a portion of the one or more feet are configured to engage a bathing surface and the at least two legs further engage the angled platform to secure the angled platform above the bathing surface;
a handle proximal an upper side of the angled platform; and
a drain proximal the lower side of the angled platform.

2. The portable ottoman of the claim 1, further comprising a cushion positioned on at least a portion of the top surface of the angled platform.

3. The portable ottoman of claim 1, further comprising a left side wall extending upward from the left side of the angled platform and a right side wall extending upward from the right side of the angled platform.

4. The portable ottoman of claim 3, further comprising a cushion positioned on at least a portion of the left side wall.

5. The portable ottoman of claim 3, further comprising a cushion positioned on at least a portion of the right side wall.

6. The portable ottoman of claim 1, wherein the angle of the angled platform is in the range of 20% to 70%.

7. The portable ottoman of claim 1, wherein the angled platform, the at least two legs, the handle and the drain are all formed as a single piece of molded plastic.

8.-11. (canceled)

12. The portable ottoman of claim 1, further comprising a front side wall extending upward from the lower side of the angled platform.

13. The portable ottoman of claim 12, wherein the drain is positioned at a lowest point proximal to where the front side wall extends upward from the lower side of the angled platform.

14. The portable ottoman of claim 13, wherein the drain comprises an elongated edge configured to operate as a second handle.

15. The portable ottoman of claim 1, wherein at least a portion of the at least two legs are configured to extend and contract in length.

16. The portable ottoman of claim 1, wherein the at least two legs consists of exactly three legs.

17. The portable ottoman of claim 1, wherein the at least two legs consists of exactly four legs.

18. The portable ottoman of claim 2, wherein the cushion is made of a foam material.

19. The portable ottoman of claim 1, wherein the drain comprises a hole extending through at least a portion of a bottom surface of the angled platform.

20. The portable ottoman of claim 1, further comprising a plug configured to seal the drain.
